(19) United States
(12) Patent Application Publication
(10) Pub. No.: US 2026/0027603 A1
(43) Pub. Date: Jan. 29, 2026

(54) Support Jig and Tank Cleaning Method

(71) Applicant: VALQUA, LTD., Tokyo (JP)

(72) Inventors: Chi Hsing Fu, Kaohsiung (TW); Chun Cheng Chen, Kaohsiung (TW)

(21) Appl. No.: 18/995,233

(22) PCT Filed: May 19, 2023
(86) PCT No.: PCT/JP2023/018769

§ 371 Date: Jan. 16, 2025

(30) Foreign Application Priority Data
Jul. 29, 2022 (JP) 2022-121123

(51) Int. Cl. B08B 9/20

(52) U.S. Cl. CPC B08B 9/20; B08B 2209/08

(57) ABSTRACT

Provided are a support jig and a tank cleaning method. Provided is a support jig for supporting a tank that is cylindrical in shape and is lying and for moving the tank rotationally, the support jig including: a plurality of bases configured to abut on an outer circumferential face of the tank slidably in a circumferential direction to the outer circumferential face; and at least one auxiliary member provided to at least one of the plurality of bases, the auxiliary member being configured to abut on the outer circumferential face of the tank slidably in the circumferential direction to the outer circumferential face, in which the plurality of bases and the auxiliary member are configured to support the tank that is lying such that the tank is allowed to move rotationally.

### CROSS-REFERENCE TO RELATED APPLICATIONS

This application is the United States national phase of International Patent Application No. PCT/JP2023/018769 filed May 19, 2023, and claims priority to Japanese Patent Application No. 2022-121123 filed Jul. 29, 2022, the disclosures of which are hereby incorporated by reference in their entireties.

### BACKGROUND OF THE INVENTION

### Field of the Invention

The present invention relates to a support jig for use in tank cleaning and a tank cleaning method with the support jig.

### Description of Related Art

A typical semiconductor process requires use of a large amount of chemical solution all the time. The purity of chemical solution is essential for inhibition of any contamination from remaining on a semiconductor device.

Conventionally, chemical solution is carried to a semiconductor plant after produced in a chemical plant and injected into a tank or is injected into a tank installed in the semiconductor plant, followed by work regarding a semiconductor process in the semiconductor plant. Thus, before injecting the chemical solution into such a tank, the tank requires advance cleaning in order to ensure that no contamination remains inside the tank. Such cleaning prevents the chemical solution from being contaminated with any contamination, so that the purity of chemical solution is kept.

### SUMMARY OF THE INVENTION

### Technical Problem

However, according to a conventional tank cleaning method, first, a tank is made to stand upright and then cleaning fluid is sprayed to clean the inside of the tank. According to such a tank cleaning method, uniform cleaning fails to be performed inside the tank and additionally contaminations on the inner wall of the tank fail to be removed because the spraying is weak in strength. Thus, in a case where chemical solution is injected into the tank, any contamination remaining inside the tank contaminates the chemical solution, resulting in a deterioration in the purity of the chemical solution.

As another conventional tank cleaning method, a tank is filled with cleaning fluid to clean the tank. For example, as in FIG. 1, cleaning fluid 6 is injected into a tank 7 standing upright to fill approximately the maximum capacity of the tank 7 (more than 90%). Then, the inner wall of the tank 7 and the cleaning fluid 6 are kept in long-term contact to remove any contamination in the tank, followed by removal of the cleaning fluid 6.

However, according to such a conventional tank cleaning method in which the cleaning fluid 6 fills the inside of the tank 7, the cleaning fluid 6 requires injecting up to approximately the maximum capacity of the tank 7. Thus, a large amount of cleaning fluid 6 is required for use and the inner wall of the tank 7 and the cleaning fluid 6 require keeping in long-term contact, leading to a huge cost of cleaning work and a huge amount of cleaning time. Thus, a deterioration is made in the cost-effectiveness of cleaning work.

According to the conventional tank cleaning method in which the cleaning fluid 6 fills the inside of the tank 7, from a viewpoint of safety, a top space inside the tank 7 is prevented from being filled with the cleaning fluid 6. Thus, the top space inside the tank 7 fails to be cleaned. Thus, in a case where chemical solution is injected into the tank 7, any contamination remaining in the top space inside the tank 7 contaminates the chemical solution to cause a deterioration in the purity of the chemical solution, leading to a bad influence on the yield of semiconductor manufacture.

As another conventional tank cleaning method, a tank is made in a lying position and then is cleaned. For example, a tank kept lying is mounted on an annular support frame such that the entire outer circumferential face of the tank is supported by the annular support frame. Then, cleaning fluid is injected into the tank and the annular support frame is rocked such that any contamination in the tank is dissolved and removed, followed by removal of the cleaning fluid as the final step. However, according to the conventional lying-tank cleaning method, the annular support frame requires advance assembling, causing a lot of time and effort. Thus, a reduction is difficult to make in cost. The support force of the annular support frame to the tank causes variations in the stress to the tank. Thus, the tank is likely to deform.

The above-described various types of problems in the related art are problems to be solved.

### Solution to Problem

In consideration of the above-described various types of disadvantages in the related art,
according to the present invention,
provided is a support jig for supporting a tank that is cylindrical in shape and is lying and for moving the tank rotationally, the support jig including:
a plurality of bases configured to abut on an outer circumferential face of the tank slidably in a circumferential direction to the outer circumferential face; and
at least one auxiliary member provided to at least one of the plurality of bases, the auxiliary member being configured to abut on the outer circumferential face of the tank slidably in the circumferential direction to the outer circumferential face, in which
the plurality of bases and the auxiliary member are configured to support the tank that is lying such that the tank is allowed to move rotationally.

In the support jig according to the present invention,
the auxiliary member includes a plurality of mount sets that abuts on the outer circumferential face of the tank slidably in the circumferential direction to the outer circumferential face.

In the support jig according to the present invention,
each of the plurality of mount sets includes at least one auxiliary-member roller provided rotatably to one of the plurality of bases, and
the auxiliary-member roller abuts on the outer circumferential face of the tank.

In the support jig according to the present invention,
the plurality of bases is provided with a plurality of the auxiliary members, and
two bases of the plurality of bases provided with the plurality of the auxiliary members are different in the number of the plurality of the auxiliary members.

In the support jig according to the present invention,
the auxiliary member is detachably provided to the at least one of the plurality of bases.

In the support jig according to the present invention,
the auxiliary member is provided adjacent to the one of the plurality of bases in an axial direction of the tank.

In the support jig according to the present invention,
the plurality of bases is arrayed along an axial direction of the tank and is mutually spaced in the axial direction of the tank.

In the support jig according to the present invention,
each of the plurality of bases includes: a base body; and a plurality of functional members that is provided to the base body and is arrayed along an outer circumferential direction of the tank, and
the plurality of functional members abuts on the outer circumferential face of the tank slidably in the circumferential direction to the outer circumferential face.

In the support jig according to the present invention,
each of the plurality of functional members includes: a support frame provided to the base body; and a plurality of base rollers provided rotatably to the support frame, and
the plurality of base rollers abuts on the outer circumferential face of the tank.

In the support jig according to the present invention,
the auxiliary-member roller has a surface to which a protective tape is attached.

In the support jig according to the present invention,
the auxiliary member is provided with an auxiliary-member-roller control device that controls a rotation rate of the auxiliary-member roller.

In the support jig according to the present invention,
each of the plurality of base rollers has a surface to which a protective tape is attached.

In the support jig according to the present invention,
the plurality of bases is provided with a base-roller control device that controls a rotation rate of the plurality of base rollers.

According to the present invention, provided is a tank cleaning method including:
a step of preparing the support jig according to claim 1;
a step of mounting a tank cylindrical in shape onto the plurality of bases and the auxiliary member in a lying position such that the plurality of bases and the auxiliary member abut on an outer circumferential face of the tank slidably in a circumferential direction to the outer circumferential face;
a step of injecting cleaning fluid into the tank; and
a cleaning step of rotating the tank that is mounted on the support jig in the lying position and has the cleaning fluid injected inside around an axial line of the tank to clean an inside of the tank with the cleaning fluid.

In the tank cleaning method according to the present invention,
the cleaning step includes rocking the tank forward and backward.

### Advantageous Effects of Invention

As above, the support jig according to the present invention enables, in the tank cleaning method, a tank to be directly mounted thereon in a lying position due to the design of the auxiliary member. Thus, a tank is not required to be mounted in advance on a conventional annular support frame in a lying position. Therefore, in comparison to a conventional lying-tank cleaning method, the tank cleaning method according to the present invention enables the time and cost of assembly of the conventional annular support frame to be cut, leading to not only labor saving with a reduction in working hours but also a reduction in cost. The auxiliary member can be freely adjusted in position. Thus, the auxiliary member is disposed at an easily deformable region of the tank, leading to effective solution to a problem of deformation of the tank in cleaning.

Due to a combination of the tank mounted in a lying position and rotation of the tank, the cleaning fluid can be agitated to dissolve any nano-contamination inside the tank. Thus, in comparison to a conventional tank cleaning method in which cleaning fluid is sprayed, the tank cleaning method according to the present invention enables uniform cleaning of the entire region inside the tank and easy removal of any contamination on the inner wall of the tank due to a strong force of rotation of the tank. Thus, even in a case where chemical solution required for a semiconductor wafer process is stored in the tank, the chemical solution in the tank is not contaminated with any nano-contamination. Thus, the purity of the chemical solution is kept high, leading to an improvement in the yield of the semiconductor wafer process.

Furthermore, the tank cleaning method according to the present invention enables, due to a combination of the tank mounted in a lying position and rotation of the tank, cleaning work with an amount of cleaning fluid that is at least half the capacity of the tank. Thus, a great reduction can be made in the usage of cleaning fluid, and additionally no step in which the inner wall of the tank and the cleaning fluid are kept in long-term contact is required. Thus, the tank cleaning method according to the present invention enables a great reduction in the cost of cleaning work and a reduction in cleaning time, leading to an improvement in the cost-effectiveness of cleaning work.

The tank cleaning method according to the present invention enables, due to a combination of the tank mounted in a lying position and rotation of the tank, cleaning work with an amount of cleaning fluid that is at least half the capacity of the tank, leading to securement of the safety of cleaning work. Furthermore, the entire region inside the tank can be cleaned. Thus, in comparison to a conventional tank cleaning method in which cleaning fluid fills the inside of a tank, due to the tank cleaning method according to the present invention, no nano-contamination remains in the entire region inside the tank after cleaning work of the tank. Thus, even in a case where chemical solution required for a semiconductor wafer process is stored in the tank, the chemical solution in the tank is not contaminated with any nano-contamination. Thus, the purity of the chemical solution is kept high, leading to an improvement in the yield of the semiconductor wafer process.

The support jig according to the present invention includes the auxiliary member designed on the basis of the tank cleaning method according to the present invention. The auxiliary member provides a reinforcement function to effectively distribute the stress to the outer circumferential face of the tank in which the cleaning fluid is stored. Thus, the support jig according to the present invention can stably support the tank in which the cleaning fluid is stored to prevent the tank from deforming.

### BRIEF DESCRIPTION OF THE DRAWINGS

FIG. 1 illustrates a conventional tank cleaning method.

FIG. 2 is a perspective view illustrating a support jig and a tank, which are separated, according to the present invention.

FIG. 3 is a perspective view illustrating a base in the support jig according to the present invention.

FIG. 4 is a partial enlarged plan view of the base in the support jig according to the present invention.

FIG. 5 is a plan view of the base in the support jig according to the present invention.

FIG. 6 is a perspective view illustrating an auxiliary member in the support jig according to the present invention.

FIG. 7 is a plan view of the auxiliary member in the support jig according to the present invention.

FIG. 8 is a perspective view illustrating an embodiment of the support jig according to the present invention.

FIG. 9 is another perspective view illustrating the embodiment of the support jig according to the present invention.

FIG. 10 is a perspective view illustrating a tank cleaning method according to the present invention.

FIG. 11 illustrates the inside of the tank mounted on a support jig according to the present invention.

FIG. 12 is a side view illustrating a state where the tank is mounted on the support jig according to the present invention.

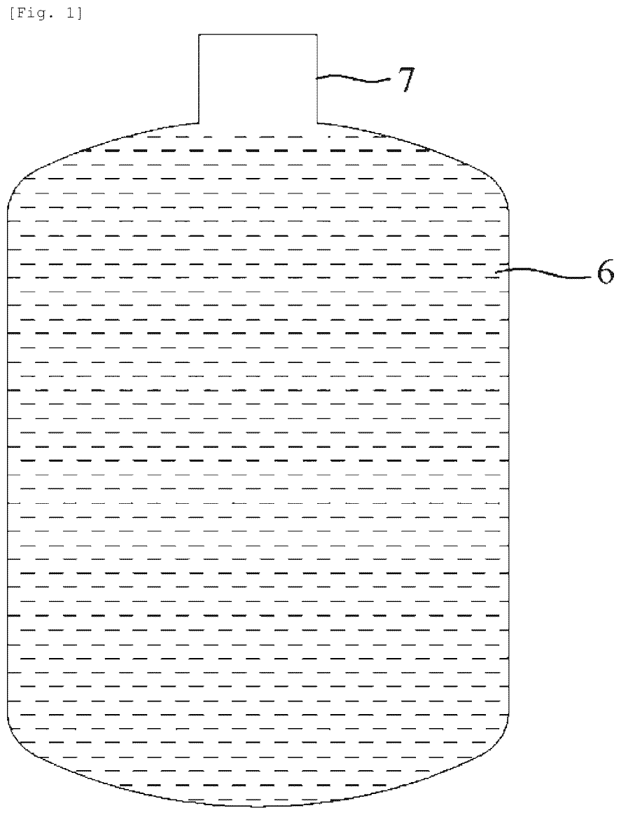

### DESCRIPTION OF THE INVENTION

Embodiments of the present invention will be described below on the basis of particular and specific embodiments. From the description disclosed herein, those skilled in the art may easily conceive other advantages or effects of the present invention.

For example, the structure, proportion, and size in each drawing herein are made suitable to the disclosure herein for easy understanding or for easy reference and thus are not limited conditions for carrying out the present invention. Provided that no influences are on obtainable effects and achievable objects of the present invention, any modifications in structure, changes in proportion, and adjustments in size should be interpreted to be included in the scope of the disclosure of the present invention. Terms, such as “on/up”, “one”, “two”, and “three”, herein are used for easy understanding or for easy reference, and thus the scope of the present invention is not limited to such terms. Any changes or adjustments thereof should be interpreted to be included in the scope of the present invention, provided that no change is substantially made in the technical description.

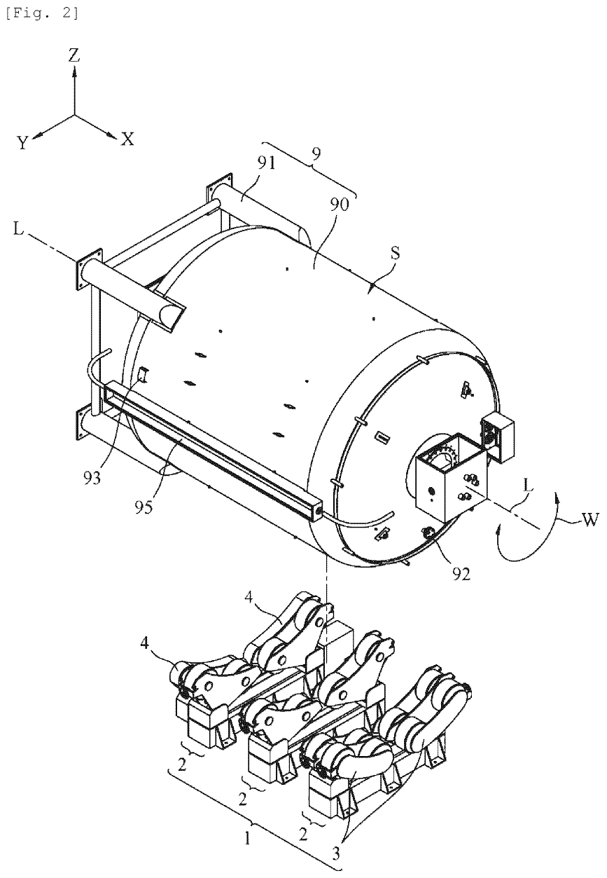

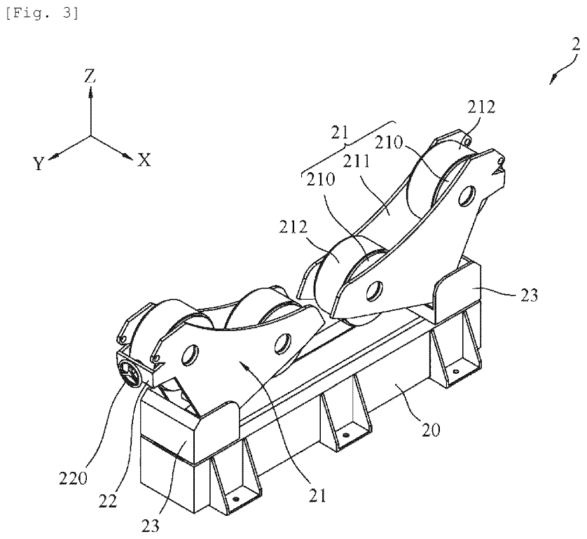

FIGS. 2 to 9 illustrate support jigs according to the present invention. As illustrated in FIG. 2, a support jig 1 according to the present invention is intended for supporting and rotating a tank 9 that is cylindrical in shape and is lying, and includes a plurality of bases 2 and at least one auxiliary member 3.

As one embodiment, the tank 9 serves as a tank for storing chemical solution and includes a tank body 90 substantially cylindrical in shape and legs 91 that support the tank body 90. The tank 9 has a metallic container structure having a diameter R of 3400 mm and a total height H of 5346 mm and has a total weight of approximately 5 t. Note that any type of standard can be applied to the tank 9 and thus the above-described standard is not limiting.

The bases 2 are disposed so as to abut on the outer circumferential face S of the tank 9 slidably in a circumferential direction W to the outer circumferential face S.

In the present embodiment, the plurality of bases 2 is arrayed along the axial direction of the tank 9 (along the direction of the axial line L of the tank 9, namely, along the direction of an axis X in an XYZ coordinate system illustrated in FIG. 2) and is mutually spaced in the axial direction of the tank 9.

Each base 2 is used as a turning roller and includes a base body 20 and a plurality of functional members 21 that is arrayed along the circumferential direction W of the tank 9 and is provided to the base body 20. The functional members 21 each abut on the outer circumferential face S of the tank 9 slidably in the circumferential direction W to the outer circumferential face S.

The functional members 21 each include a support frame 211 provided to the base body 20 and a plurality of base rollers 210 provided rotatably to the support frame 211. The plurality of base rollers 210 abuts on the outer circumferential face S of the tank 9. Preferably, each base roller 210 has a surface provided with a protective tape 212, such as a soft pad, for example, made of black rubber. For example, the protective tape 212 is made of such a polyethylene (PE) material as indicated in the following Table 1.

TABLE 1

| | | Specified | Measurement |
|---|---|---|---|
| Item | Unit | value | method |
| Thickness | mm | 0.08 ± 0.005 | AFERA5006 |
| Width | mm | Customized | |
| | | standard ±0.2 | |
| Peeling | Cn/cm | 120 | AFERA4001 |
| strength | | | |
| Breaking | Longitudinal | >1.2 daN/cm | AFERA5004 |
| strength | direction | | |
| | Lateral | >0.9 daN/cm | |
| | direction | | |
| Breaking | Longitudinal | >200% | AFERA5004 |
| strength | direction | | |
| | Lateral | >400% | |
| | direction | | |

In the present embodiment, the support frame 211 is secured to the base body 20 and the respective rotary shafts of the base rollers 210 are connected to the support frame 211. For example, two base rollers 210 are disposed to one support frame 211.

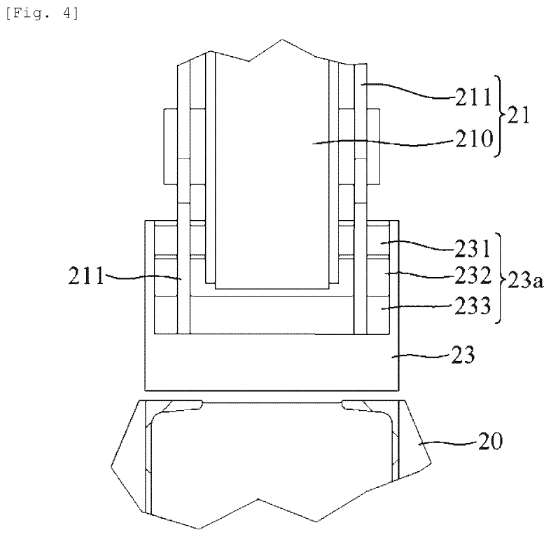

The support frame 211 may be secured to the base body 20 through an adjustment member 23. The adjustment member 23 has a step structure 23a (refer to FIG. 4), and the support frame 211 is secured to one of steps 231, 232, and 233. Thus, as necessary, a change is made in the height position of the support frame 211, so that the respective positions of the base rollers 210 can be adjusted to the outer circumferential face S of the tank 9. Thus, depending on the size of the diameter R of the tank 9 or an easily deformable region of the outer circumferential face S of the tank 9, the corresponding functional member 21 can be adjusted to be disposed at a proper position. Any type of member can be used as the adjustment member 23 and thus the above example is not limiting.

The functional members 21 are disposed symmetrically with respect to a boundary extending in a direction orthogonal to the longitudinal direction of the base body 20 (in the direction of the axis X) through the center of the base body 20 such that the base rollers 210 allow the tank 9 to rotate reliably.

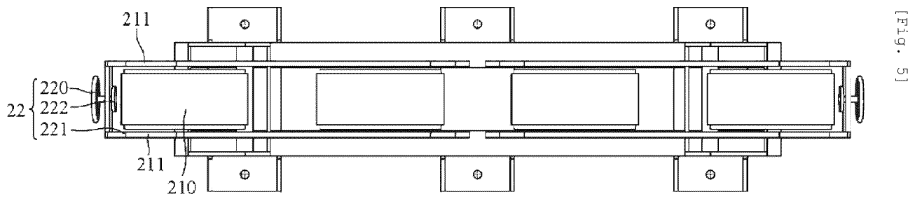

Note that the bases 2 are each provided with at least one brake structure 22. As in FIG. 5, the brake structure 22 includes an operation handle 220, a bracket 221, and a friction pad 222 for the operation handle 220, in which the operation handle 220 and the friction pad 222 are provided to the corresponding support frame 211 through the bracket 221. Manual rotation of the operation handle 220 enables an adjustment in the distance or degree of approach between the friction pad 222 and the corresponding base roller 210. Thus, an increase or a decrease made as necessary in the friction force therebetween enables the corresponding base roller 210 to stop rotating.

The auxiliary member 3 is provided to one of the plurality of bases 2 (to an outer base 2 as in FIG. 2) so as to abut on the outer circumferential face S of the tank 9 slidably in the circumferential direction W to the outer circumferential face S.

In the present embodiment, the auxiliary member 3 is detachably provided to at least one of the plurality of bases 2. As necessary, an adjustment can be made in the abutment position of the auxiliary member 3 to the outer circumferential face S of the tank 9. In order to assist the bases 2 in supporting the tank 9, the auxiliary member 3 is disposed adjacently to the corresponding base 2 in the axial direction of the tank 9.

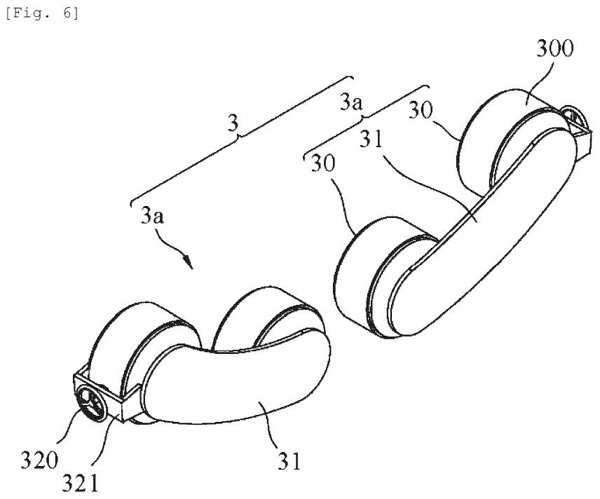

As in FIG. 6, the auxiliary member 3 includes a plurality of mount sets 3a (e.g., two mount sets) that abuts on the outer circumferential face S of the tank 9 slidably in the circumferential direction W to the outer circumferential face S.

The mount sets 3a each include at least one auxiliary-member roller 30 provided rotatably to the corresponding base 2. The auxiliary-member roller 30 abuts on the outer circumferential face S of the tank 9. Preferably, the auxiliary-member roller 30 is attached to the shaft of the corresponding base roller 210 and has a surface provided with a protective tape 300, such as a soft pad, for example, made of black rubber. For example, the protective tape 300 is made of such a polyethylene (PE) material as indicated in the following Table 2.

TABLE 2

| | | Specified | Measurement |
|---|---|---|---|
| Item | Unit | value | method |
| Thickness | mm | 0.08 ± 0.005 | AFERA5006 |
| Width | mm | Customized | |
| | | standard ±0.2 | |
| Peeling | Cn/cm | 120 | AFERA4001 |
| strength | | | |
| Breaking | Longitudinal | >1.2 daN/cm | AFERA5004 |
| strength | direction | | |
| | Lateral | >0.9 daN/cm | |
| | direction | | |
| Breaking | Longitudinal | >200% | AFERA5004 |
| strength | direction | | |
| | Lateral | >400% | |
| | direction | | |

In the present embodiment, the mount sets 3a each include a plurality of auxiliary-member rollers 30 (e.g., two auxiliary-member rollers). The plurality of auxiliary-member rollers 30 is connected through one securing frame 31. For example, the structure of each mount set 3a is substantially identical to the structure of the corresponding functional member 21. Preferably, the mount sets 3a are disposed symmetrically with respect to a boundary extending in a direction orthogonal to the longitudinal direction of the base body 20 (in the direction of the axis X) through the center of the base body 20 such that the auxiliary-member rollers 30 allow the tank 9 to rotate reliably.

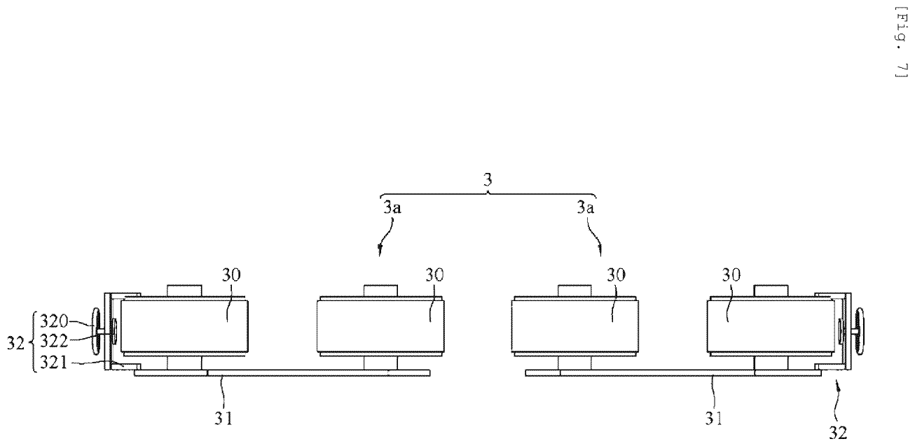

The auxiliary member 3 is provided with at least one brake structure 32. As in FIG. 7, the brake structure 32 includes an operation handle 320, a bracket 321, and a friction pad 322 for the operation handle 320, in which the operation handle 320 and the friction pad 322 are provided to the corresponding securing frame 31 through the bracket 321. Manual rotation of the operation handle 320 enables an adjustment in the distance or degree of approach between the friction pad 322 and the corresponding auxiliary-member roller 30. Thus, an increase or a decrease made as necessary in the friction force therebetween enables the corresponding auxiliary-member roller 30 to stop rotating.

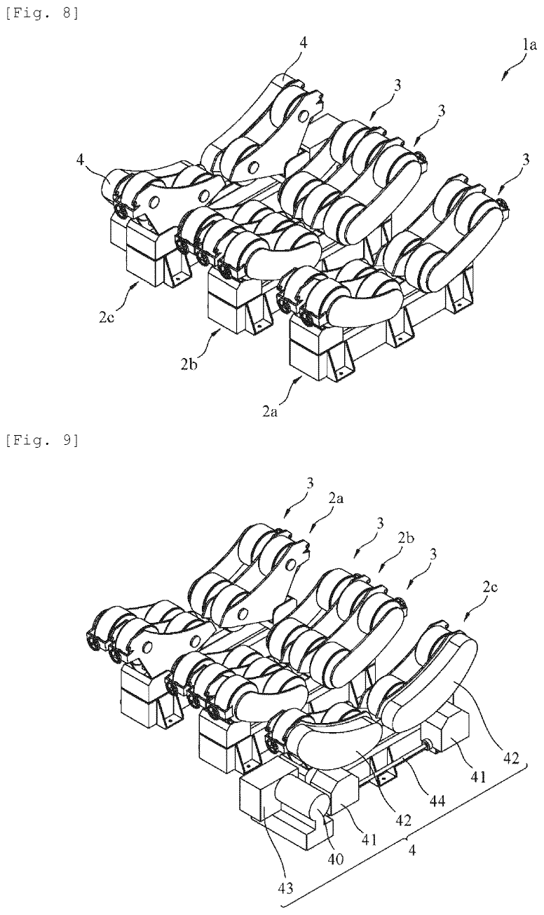

A required number of auxiliary members 3 can be disposed in the support jig 1. As in FIG. 8, auxiliary members 3 are disposed to a plurality of bases 2a and 2b (two bases). In a support jig 1a illustrated in FIG. 8, for example, the bases 2a and 2b, which are provided with the auxiliary members 3, are different in the number of provided auxiliary members. The intermediate base 2b is provided with two auxiliary members 3 and the outer base 2a is provided with one auxiliary member 3.

In the support jig 1, the bases 2, 2a, 2b, and 2c (only the base 2c in FIG. 8) may be each provided with a base-roller control device 4 that controls the rotation rate of base rollers 210. The base-roller control device 4 may control the rotation rate of base rollers 210 to rotate the tank 9, for example, such that such specified values as indicated in the following Table 3 are fulfilled.

TABLE 3

| Item | Specified value |
|---|---|
| Number of rotations | 0.1 rpm to 0.3 rpm |
| Angle | 0° to 360° |
| Number of times of reciprocation | 5 times to 20 times |

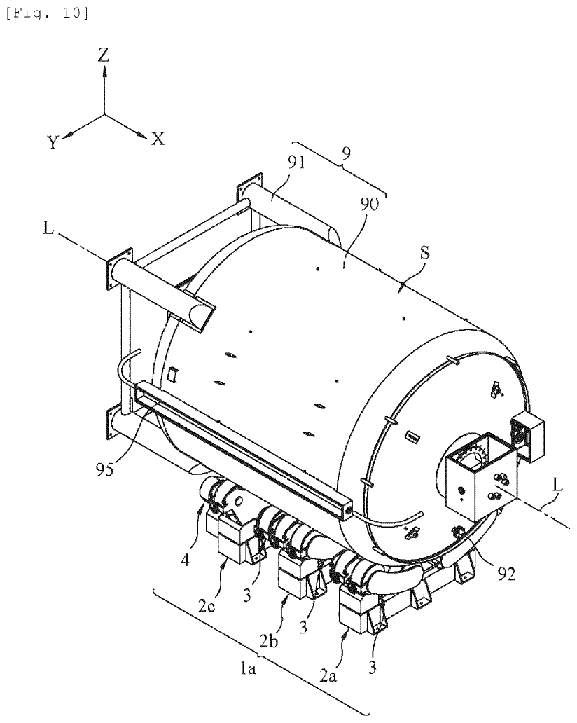

As in FIG. 9, the base-roller control device 4 includes a motor 40, a transmission decelerator 41 that operates due to the motor 40, and a plurality of sprocket drive structures 42 linked with the transmission decelerator 41.

In the present embodiment, the motor 40 is equipped with a motor decelerator 43. Two base rollers 210 may rotate in synchronization due to one sprocket drive structure 42. In addition, an interlock operation of a plurality of transmission decelerators 41 through one transmission shaft 44 may cause synchronous driving of the plurality of sprocket drive structures 42 such that the plurality of base rollers 210 of the functional members 21 rotates in synchronization.

Such a base-roller control device 4 may be provided to at least one base of the bases 2 or at least one base of the bases 2a, 2b, and 2c as necessary, for example, to a base 2 provided with no auxiliary member 3 illustrated in FIG. 2 or the base 2c provided with no auxiliary member 3 illustrated in FIG. 8. Thus, the base-roller control device 4 operates, in a case where the support jig 1 is used, only the corresponding base 2 or operates, in a case where the support jig 1a is used, only the corresponding base 2c, so that the tank 9 can rotate. Then, the tank 9 slides on the base 2, which is provided with the auxiliary member 3, to rotate the plurality of base rollers 210 of the base 2, which is provided with the auxiliary member 3, or slides on the bases 2a and 2b, which are provided with the auxiliary members 3, to rotate the plurality of base rollers 210 of the bases 2a and 2b, which is provided with the auxiliary members 3.

As above, the base rollers 210 of the base 2, to which the base-roller control device 4 is directly connected, may be determined as a drive roller set, and the base rollers 210 of the bases 2 that rotate in response to sliding of the tank 9 and the auxiliary-member rollers 30 of the auxiliary member 3 that operate together therewith may be determined as a driven roller set. In addition, the base rollers 210 of the base 2c, to which the base-roller control device 4 is directly connected, may be determined as a drive roller set, and the base rollers 210 of the bases 2a and 2b that rotate in response to sliding of the tank 9 and the auxiliary-member rollers 30 of the auxiliary members 3 that operate together therewith may be determined as a driven roller set.

In the support jig 1, the auxiliary member 3 may be provided with an auxiliary-member-roller control device that controls the rotation rate of auxiliary-member rollers 30 (the auxiliary-member-roller control device is identical in mechanism to the base-roller control device 4 and thus is not illustrated). The auxiliary-member-roller control device may control the rotation rate of auxiliary-member rollers 30 to rotate the tank 9, for example, such that such specified values as indicated in the following Table 4 are fulfilled.

TABLE 4

| Item | Specified value |
|---|---|
| Number of rotations | 0.1 rpm to 0.3 rpm |
| Angle | 0° to 360° |
| Number of times of reciprocation | 5 times to 20 times |

For example, in the support jig 1a illustrated in FIG. 9, the base-roller control device 4 provided to the base 2c may be replaced with an auxiliary member roller control device and the auxiliary member roller control device may be disposed to the auxiliary member 3 provided to the base 2a. In this case, since each auxiliary-member roller 30 and the corresponding base roller 210 are attached to the same shaft, two base rollers 210 and two auxiliary-member rollers 30 rotate in synchronization due to one sprocket drive structure 42. In this case, the base rollers 210 of the base 2a and the auxiliary-member rollers 30 of the auxiliary member 3 that the auxiliary-member-roller control device directly drives may be determined as a drive roller set, and the base rollers 210 of the other bases 2b and 2c and the auxiliary-member rollers 30 of the auxiliary members 3 that operate together therewith may be determined as a driven roller set.

In a case where the support jig 1 is used, with the plurality of bases 2 and the auxiliary member 3 supporting the tank 9 that is lying, the base rollers 210 and the auxiliary-member rollers 30 rotate such that the tank 9 is allowed to rotate or in a case where the support jig 1a is used, with the bases 2a, 2b, and 2c and the auxiliary members 3 supporting the tank 9 that is lying, the base rollers 210 and the auxiliary-member rollers 30 rotate such that the tank 9 is allowed to rotate. Thus, an increase in the number of mount rollers due to addition of auxiliary-member rollers 30 causes force applied to an array of base rollers 210 to be distributed over a plurality of arrays of rollers (auxiliary-member rollers 30 and base rollers 210). Thus, an increase is made in the area of a face to which force is applied in the outer circumferential face S of the tank 9, so that high pressure at one place can be distributed over a plurality of places for low pressure. That is, distribution of the weight of the tank 9 over a plurality of arrays of rollers causes a reduction in the pressure from the tank 9 to each base 2 or each of the bases 2a, 2b, and 2c. Thus, the support jigs 1 and 1a according to the present invention can be favorably used in cleaning work to the tank 9.

Here, as in FIGS. 2 to 9, according to the present invention, further provided is a cleaning method for cleaning work to the tank 9. Specific steps in the cleaning method for cleaning work will be described below.

In the present embodiment, the support jig 1a illustrated in FIG. 8 is adopted. Then, on the basis of usage of the support jig 1a, the face on which the bases 2a, 2b, and 2c are installed (e.g., an environmental surface, such as the ground) is defined as a criterial face. The direction in which the tank 9 is lying is defined as a fore-aft direction (namely, the axial direction of the tank 9, for example, the direction of an axis X in an XYZ coordinate system illustrated in FIG. 10). The direction orthogonal to the fore-aft direction along the criterial face is defined as a left-right direction (e.g., the direction of an axis Y in the XYZ coordinate system illustrated in FIG. 10). The direction in which the tank 9 stands upright before lying is defined as an up-down direction (e.g., the direction of an axis Z in the XYZ coordinate system illustrated in FIG. 10).

In a tank cleaning method according to the present invention, first, as in FIG. 10, the tank 9 cylindrical in shape is made lying by tilting and then is mounted on the bases 2a, 2b, and 2c and the auxiliary members 3 such that the bases 2a, 2b, and 2c and the auxiliary members 3 abut on the outer circumferential face S of the tank 9 slidably in the circumferential direction W to the outer circumferential face S.

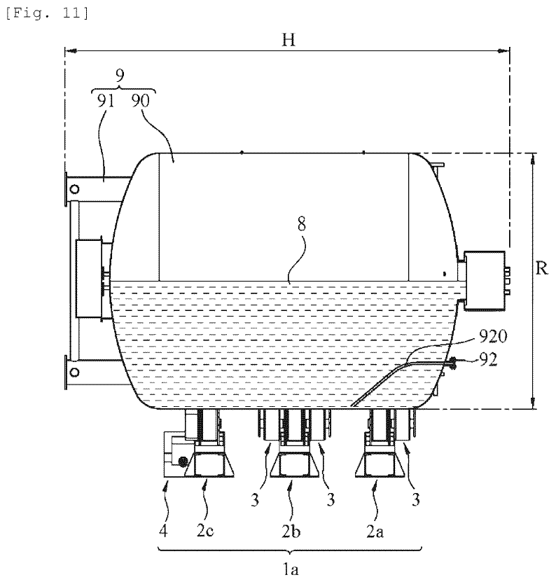

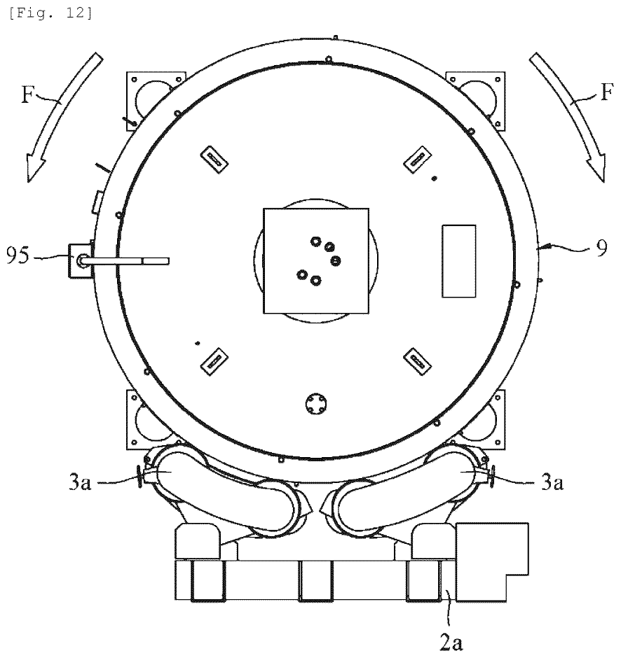

Next, as in FIG. 11, cleaning fluid 8 is injected into the tank body 90 through an inlet/outlet port 92 of the tank 9. Here, the cleaning fluid 8 does not require injecting up to the maximum capacity of the tank body 90 of the tank 9 but requires injecting up to approximately half the maximum capacity. For example, an inlet/outlet tube 920 inserted inside the tank body 90 is connected to the inlet/outlet port 92. Thus, the cleaning fluid 8 is injected into the tank body 90 through the inlet/outlet tube 920. Then, a fluid-level measurement device 95 detects the volume of the cleaning fluid 8 in the tank body 90.

In the present embodiment, the cleaning fluid 8 contains hydrogen peroxide accounting for 31% and has a density of 1.11 g/cm³. The maximum amount of the cleaning fluid 8 is half the maximum capacity of the tank body 90 (a weight of approximately 20 t). Thus, when the tank 9 rotates in contact with the base rollers 210 and the auxiliary-member rollers 30, the cleaning fluid 8 is agitated in the tank body 90.

Note that, as another procedure, before the tank 9 is tilted, first, the cleaning fluid 8 may be injected into the tank body 90 and then the tank 9 may be made lying by tilting. Then, the lying tank 9 may be mounted on the bases 2a, 2b, and 2c and the auxiliary members 3.

Next, the tank 9, which is mounted on the support jig 1a in a lying position and has the cleaning fluid 8 injected inside, is rotated around the axial line L of the tank 9, so that the inside of the tank 9 is cleaned with the cleaning fluid 8.

In the present embodiment, the base rollers 210 and the auxiliary-member rollers 30 are moved rotationally through the motor 40 to rotate the tank 9. Thus, the tank 9, which has the cleaning fluid 8 injected inside, rotates around the axial line L of the tank 9 as a rotation axis, so that the cleaning fluid 8 is agitated inside the tank body 90. Thus, the inside of the tank body 90 is cleaned with the cleaning fluid 8 in agitation.

The respective positions of the bases 2a, 2b, and 2c can be freely adjusted and the auxiliary members 3 can be feely disposed. Thus, the base rollers 210 and the auxiliary-member rollers 30 can avoid interference with an attachment 93 on the outer circumferential face S of the tank 9 (e.g., the fluid-level measurement device 95 provided at a required position). Furthermore, as a method of rotating the tank 9, like rotation directions F illustrated in FIG. 12, rocking in both the counterclockwise direction and the clockwise direction can be performed or a rotation of 360° in the counterclockwise direction or in the clockwise direction can be made. For example, the tank 9 can be rocked around the rotation axis by an angle of approximately 180° in the counterclockwise direction and by an angle of 180° in the clockwise direction in FIG. 12. Alternatively, with avoidance of interference with the attachment 93 on the outer circumferential face S of the tank 9, the tank 9 can be greatly rocked by an angle of approximately 360° in both the counterclockwise direction and the clockwise direction in FIG. 12. Thus, in a cleaning step, the tank 9 can rock forward and backward, namely, counterclockwise and clockwise.

The angle by which the tank 9 can rotate varies depending on the position of the attachment 93 on the outer circumferential face S of the tank 9. Thus, a change in the position of the attachment 93 on the outer circumferential face S of the tank 9 enables a change in the angle by which the tank 9 can rotate.

After the cleaning work is completed, the cleaning fluid 8 is discharged from the tank body 90 through the inlet/outlet tube 920 and the inlet/outlet port 92 of the tank 9. Then, the cleaning fluid 8 is transported to a predetermined location, such as a waste-fluid collecting station, outside the tank 9, for example.

Thus, in the tank cleaning method according to the present invention, mainly due to the installation of the auxiliary member/auxiliary members 3, the tank 9 can be directly mounted on the support jig 1 or 1a in a lying position. Therefore, the tank 9 requires no mounting, in a lying position, on a conventional annular support frame. Therefore, in comparison to a lying-tank cleaning method based on the conventional annular support frame, the tank cleaning method according to the present invention has the following advantages.
(1) An improvement in efficiency achieves labor saving with a reduction in working hours and a reduction in cleaning cost. According to the present invention, the time and cost of assembly of the conventional annular support frame can be cut, enabling simplification in steps. Thus, a reduction can be made in the number of people for jig detachment and use of a large working machine, for example, for crane work can be omitted.
(2) The support jig 1 or 1a light in weight enables the strength demand of the ground at the site of cleaning work to be reduced by approximately 20%, so that the ground at the site can be protected against damage or subsidence.
(3) An improvement is made in safety. After the support jig 1 or 1a in use is first positioned at the site of cleaning work, attachment/detachment work of the tank 9 in the up-down direction (e.g., in the direction of an axis Z in the XYZ coordinate system illustrated in FIG. 2) is allowed. Thus, a worker does not need to carry out risky attachment/detachment work around the support jig 1 or 1a (in the left-right direction and in the fore-aft direction).
(4) An increase is made in the angle of rotation due to the support jig 1 or 1a. Since there is no need to use the conventional annular support frame, the support jig 1 or 1a in use enables an increase in the angle of rotation and enables the tank 9 to rotate, for example, by 270° or more or by 360°.

Since the support jig 1 according to the present invention includes the bases 2 and the auxiliary member 3 and the support jig 1a according to the present invention includes the bases 2a, 2b, and 2c and the auxiliary members 3, the stress to the outer circumferential face S of the tank 9 in rotation can be distributed. The position at which an auxiliary member 3 is installed can be freely adjusted, and thus an auxiliary member 3 is disposed at an easily deformable region of the tank 9, leading to effective solution to a problem of deformation of the tank 9 in cleaning. In particular, a configuration in which four rollers per array support the weight of the tank 9 is adopted, leading to further effective distribution of the stress on the location of the rollers of the outer circumferential face S of the tank 9 in which the cleaning fluid 8 is injected. Therefore, the support jigs 1 and 1a can each reliably support the tank 9, in which the cleaning fluid 8 is injected, without deformation of the tank 9.

Thus, according to the present invention, due to a combination of the tank 9 that is lying and rotation of the tank 9, the cleaning fluid 8 is agitated to remove any contamination inside the tank 9. Therefore, in comparison to a conventional tank cleaning method in which cleaning fluid is sprayed, due to the angle by which the tank 9 rotates (up to 360° is allowable) in the tank cleaning method according to the present invention, the entire region inside the tank body 90 of the tank 9 can be effectively and uniformly cleaned. The cleaning fluid 8 inside the tank is agitated hard by a strong force of rotation of the tank 9, so that any contamination on the inner-wall face of the tank body 90 of the tank 9 can be easily removed. Thus, even in a case where chemical solution required for a semiconductor process is injected into the tank body 90 of the tank 9, the chemical solution in the tank body 90 of the tank 9 is not contaminated with any type of contamination. Thus, the purity of the chemical solution can be kept high, leading to securement of the yield of the semiconductor processing.

In comparison to a conventional tank cleaning method in which cleaning fluid fills the inside of a tank, the tank cleaning method according to the present invention enables cleaning work, due to a combination of the tank 9 that is lying and rotation of the tank 9, in a case where the cleaning fluid 8 is injected, by half the maximum capacity, into the tank body 90 of the tank 9. Thus, a great reduction can be made in the usage of the cleaning fluid 8, and additionally no step in which the inner wall of the tank and the cleaning fluid are kept in long-term contact is required. Therefore, the tank cleaning method according to the present invention enables a reduction in the cost of cleaning work and a reduction in cleaning time, leading to an improvement in the cost-effectiveness of cleaning work.

In comparison to the conventional tank cleaning method in which cleaning fluid fills the inside of a tank, the tank cleaning method according to the present invention enables cleaning work, due to a combination of the tank 9 that is lying and rotation of the tank 9, in a case where the cleaning fluid 8 is injected, by half the maximum capacity, into the tank body 90 of the tank 9, leading to an improvement in the safety of cleaning work.

The support jig 1 according to the present invention includes the auxiliary member 3 installed mainly as necessary and the support jig 1a according to the present invention includes the auxiliary members 3 installed mainly as necessary such that the tank 9 has an enhanced resistance to deformation at the time of mounting in a lying position and at the time of rotation (namely, a reinforcement function provided by the support jig 1). Thus, the stress to the outer circumferential face S of the tank 9 in which the cleaning fluid 8 is injected (e.g., the centrifugal force due to rotation) is effectively distributed, resulting in solution to a problem of stress concentration. The support jigs 1 and 1a can each reliably support the tank 9 in which the cleaning fluid 8 is injected (a total weight of approximately 25 t), and thus the tank 9 is prevented from deforming (regardless of whether the cleaning fluid 8 is injected).

As described above, the support jigs 1 and 1a and the tank cleaning method according to the present invention enable omission of the conventional annular support frame because of the installation of the auxiliary member/auxiliary members 3, achievement of cleaning work enabling a high cleaning effect, and a reduction in cleaning time. Thus, for example, a reduction can be made in the start-up time of a semiconductor process (in the preparation time of a production line). Thus, the support jigs 1 and 1a and the tank cleaning method according to the present invention are advantageous to development of semiconductor processes.

The tank cleaning method according to the present invention enables a considerable amount of rotation in the cleaning step based on lying-tank rotation because of no limitation due to the conventional annular support frame, fulfilling a clean level required for a highly accurate process like a semiconductor process.

The above embodiments are illustrative of the principle of the present invention and effects thereof, and thus the present invention is not limited to the embodiments. Those skilled in the art may conceive modifications of the above embodiments without departing from the scope of the sprit or gist of the present invention. That is, the extent of protection of the present invention is included in the scope of the claims.

### REFERENCE SIGNS LIST

1 Support jig
1a Support jig
2 Base
2a Base
2b Base
2c Base
3 Auxiliary member
3a Mount set
4 Base-roller control device
6 Cleaning fluid
7 Tank
8 Cleaning fluid
9 Tank
20 Base body
21 Functional member
22 Brake structure
23 Adjustment member
23a Step structure
30 Auxiliary-member roller
31 Securing frame
32 Brake structure
40 Motor
41 Transmission decelerator
42 Sprocket drive structure
43 Motor decelerator
44 Transmission shaft
90 Tank body
91 Leg
92 Inlet/outlet port
93 Attachment
95 Fluid-level measurement device
210 Base roller
211 Support frame
212 Protective tape
220 Operation handle
221 Bracket
222 Friction pad
231 Step
232 Step
233 Step
300 Protective tape
320 Operation handle
321 Bracket
322 Friction pad
920 Inlet/outlet tube
F Rotation direction
H Total height
L Axial line
R Diameter
S Outer circumferential face
W Circumferential direction
X Axis
Y Axis
Z Axis

1. A support jig for supporting a tank that is cylindrical in shape and is lying and for moving the tank rotationally, the support jig comprising:
a plurality of bases configured to abut on an outer circumferential face of the tank slidably in a circumferential direction to the outer circumferential face; and
at least one auxiliary member provided to at least one of the plurality of bases, the auxiliary member being configured to abut on the outer circumferential face of the tank slidably in the circumferential direction to the outer circumferential face, wherein
the plurality of bases and the auxiliary member are configured to support the tank that is lying such that the tank is allowed to move rotationally.

2. The support jig according to claim 1, wherein the auxiliary member comprises a plurality of mount sets that abuts on the outer circumferential face of the tank slidably in the circumferential direction to the outer circumferential face.

3. The support jig according to claim 2, wherein
each of the plurality of mount sets comprises at least one auxiliary-member roller provided rotatably to one of the plurality of bases, and
the auxiliary-member roller abuts on the outer circumferential face of the tank.

4. The support jig according to claim 1, wherein
the plurality of bases is provided with a plurality of the auxiliary members, and
two bases of the plurality of bases provided with the plurality of the auxiliary members are different in the number of the plurality of the auxiliary members.

5. The support jig according to claim 1, wherein the auxiliary member is detachably provided to the at least one of the plurality of bases.

6. The support jig according to claim 1, wherein the auxiliary member is provided adjacent to the one of the plurality of bases in an axial direction of the tank.

7. The support jig according to claim 1, wherein the plurality of bases is arrayed along an axial direction of the tank and is mutually spaced in the axial direction of the tank.

8. The support jig according to claim 1, wherein
each of the plurality of bases comprises: a base body; and a plurality of functional members that is provided to the base body and is arrayed along an outer circumferential direction of the tank, and
the plurality of functional members abuts on the outer circumferential face of the tank slidably in the circumferential direction to the outer circumferential face.

9. The support jig according to claim 8, wherein
each of the plurality of functional members comprises: a support frame provided to the base body; and a plurality of base rollers provided rotatably to the support frame, and
the plurality of base rollers abuts on the outer circumferential face of the tank.

10. The support jig according to claim 3, wherein the auxiliary-member roller has a surface to which a protective tape is attached.

11. The support jig according to claim 3, wherein the auxiliary member is provided with an auxiliary-member-roller control device that controls a rotation rate of the auxiliary-member roller.

12. The support jig according to claim 9, wherein each of the plurality of base rollers has a surface to which a protective tape is attached.

13. The support jig according to claim 9, wherein the plurality of bases is provided with a base-roller control device that controls a rotation rate of the plurality of base rollers.

14. A tank cleaning method comprising:
a step of preparing the support jig according to claim 1;
a step of mounting a tank that is cylindrical in shape onto the plurality of bases and the auxiliary member in a lying position such that the plurality of bases and the auxiliary member abut on an outer circumferential face of the tank slidably in a circumferential direction to the outer circumferential face;
a step of injecting cleaning fluid into the tank; and
a cleaning step of rotating the tank that is mounted on the support jig in the lying position and has the cleaning fluid injected inside around an axial line of the tank to clean an inside of the tank with the cleaning fluid.

15. The tank cleaning method according to claim 14, wherein the cleaning step includes rocking the tank forward and backward.
